(19) United States
(12) Patent Application Publication
(10) Pub. No.: US 2003/0089370 A1
(43) Pub. Date: May 15, 2003

(54) Folding hood for a personal therapy compartment

(76) Inventors: Steven J. Daffer, Edina, MN (US); Richard W. Jostrom, Mound, MN (US)

Correspondence Address: WESTMAN, CHAMPLIN & KELLY, INTERNATIONAL CENTRE-SUITE 1600, 900 SECOND AVENUE SOUTH, MINNEAPOLIS, MN, 55402-3319, US

(21) Appl. No.: 10/291,185

(22) Filed: Nov. 8, 2002

Related U.S. Application Data
(60) Provisional application No. 60/338,157, filed on Nov. 13, 2001.

(51) Int. Cl. A62B 17/04; A62B 18/00

(52) U.S. Cl. 128/201.24; 128/202.12

(57) ABSTRACT

The invention is a personal therapy compartment with an attached hood. The hood portion has curved nested sections that extend to a closed position to cover a major portion of the space above a user's head and retracts to an open position.

### CROSS REFERENCE TO RELATED APPLICATION

The present application is based on and claims the benefit of U.S. Provisional Patent Application Serial No. 60/338,157, filed Nov. 13, 2001, the content of which is hereby incorporated by reference in its entirety.

### BACKGROUND OF THE INVENTION

The present invention is a hood that attaches to a personal therapy compartment, and which will collapse from an extended position, wherein it covers a substantial area above the head of a user, to a retracted position wherein the area above the head of the user is substantially open.

In prior art, personal therapy compartments have been advanced that use various features for personal therapy treatment for the comfort and enjoyment of people, as well as therapeutic effects. For example, U.S. Pat. No. 5,101,809 shows such a personal therapy compartment with a vibrating bed and heater controls. In addition, U.S. Pat. No. 5,645,578 shows a personal therapy compartment with a hinged hood that will cover the head of a user. The disclosures of these patents are incorporated by reference.

### SUMMARY OF THE INVENTION

The present invention relates to a retractable hood for the use with a personal therapy compartment that is made into interleaving or nested “iris” hoop like sections which can be moved about a pivot axis to a position wherein it covers a substantial portion of the area above the head of a user to enclose the area. The hood has pivoting sections that will pivot to a retracted position, where the area above the head of the user is substantially open.

The hood can be installed on existing units, if desired, and provide an enclosure for limiting the space above the user's head. This permits aromatherapy, steam, or the like to be more easily contained over the head of the user.

### BRIEF DESCRIPTION OF THE DRAWINGS

FIG. 1 is a perspective view of a personal therapy compartment having a hood made according to the present invention installed thereon;

FIG. 2 is a side elevational view of the device of FIG. 1 with parts broken away;

FIG. 3 is a top plan view of the hood shown removed from the compartment;

FIG. 4 is a front view of the folding hood taken generally along lines 4--4 in FIG. 3;

FIG. 5 is a view similar to FIG. 4, the opposite side of FIG. 4;

FIG. 6 is an enlarged fragmentary sectional view of the hood of the present invention; and

FIG. 7 is a fragmentary side elevational view showing the hood in a retracted position.

### DETAILED DESCRIPTION OF THE ILLUSTRATIVE EMBODIMENTS

FIG. 1 illustrates a personal therapy compartment 10, and includes base assembly 11, having supporting pedestal 12 to provide support on a floor surface. Base assembly 11 is formed with hinged cover 14 that raises upwardly as indicated by arrow 16 about a hinge at the end illustrated generally at 18. The construction of the therapy compartments is well known, and is illustrated in U.S. Pat. No. 5,645,578 for example. Other means of hinging or attaching cover 14 to base assembly 11 may be employed if desired. Cover 14 may be also be removable and replaceable.

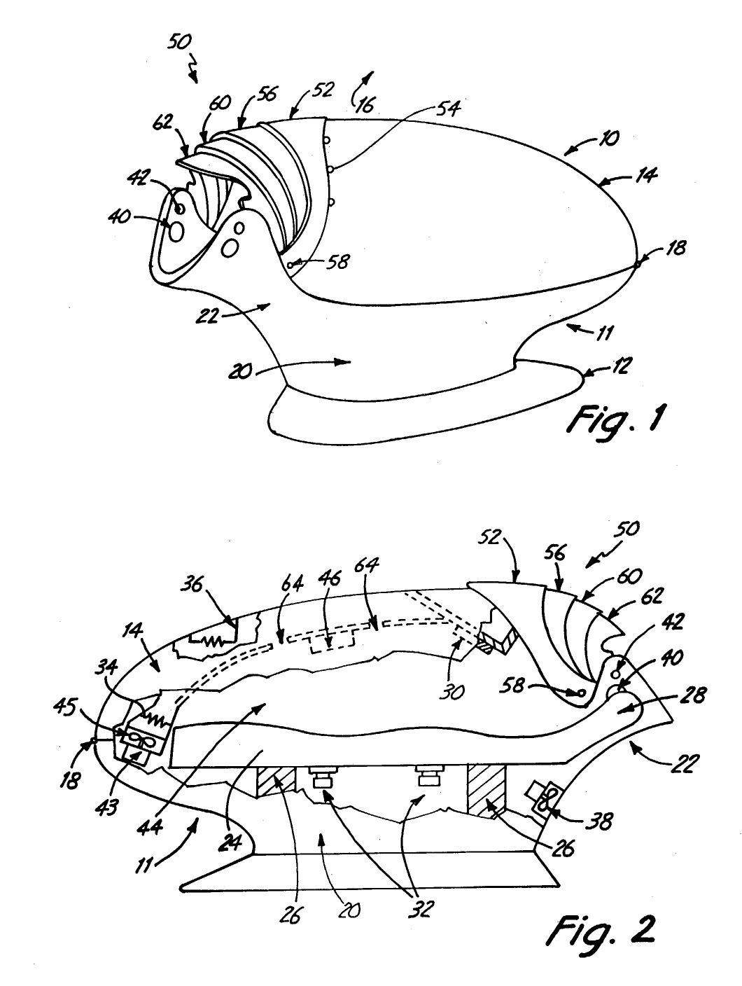

Base assembly 11 includes interior bed portion 20, and headrest portion 22. As shown in FIG. 2, where cover 14 is broken away, bed 24 can be supported on suitable supports 26, in main base portion 11. Headrest pillow 28 is provided in headrest portion 22. Headrest pillow 28 can be positioned in a desired location relative to control panel 30 adapted to be usable to a person lying on bed 24. Control panel 30 can be used for actuating vibrators such as that shown at 32, heaters, such as that illustrated generally at 34, or heat lamps 36. Additionally, cool air blower 38 can be provided for blowing air onto a user's head through a duct outlet shown at 40.

In compartments that are used for aromatherapy or a steam sauna, a steam generator illustrated at 43 can be on the interior of the cover 14. Alternately, a steam generator illustrated at 46 can be placed in interior chamber 44 of the housing. Fan 45 can blow steam or aroma into interior chamber 44 through inlets 64. The discharge of steam or aroma can be from outlets 42 adjacent the head of a user resting on the pillow 28 and lying on the bed 24.

A retractable hood 50 made according to the present invention is installed on cover 14. Hood 50 is segmented and made so that it can be retracted partially or fully. As shown in FIGS. 1 and 2 in its fully extended position hood 50 will cover substantially all the space above pillow 28 in headrest portion 22, to limit the opening proximate instrument panel 30.

The hood 50 of the present invention is made up of a plurality of curved folding or nested sections, including stationary section 52 that is secured to the edge of cover 14 proximate the head of the user. Stationary section 52 can be secured with suitable adhesives, or screws or fasteners illustrated at 54, but stationary section 52 remains in place on cover 14 and is securely fastened thereto. Stationary section 52 provides a mount for second section 56 that is pivoted on pivot pins 58 about stationary section 52, along with third section 60 and fourth section 62. The second, third and fourth sections 56, 60 and 62 all are pivoted on the same pivot pins 58. As illustrated, sections 56, 60, 62 are decreasing in size from stationary section 52 attached to cover 14 towards fourth segment 62 closest the top of the user's head. The outer edge of the smallest section 62 can be formed in a curved, scalloped edge such as that shown at 64 that is made to have the desired shape to permit air circulation or other functions.

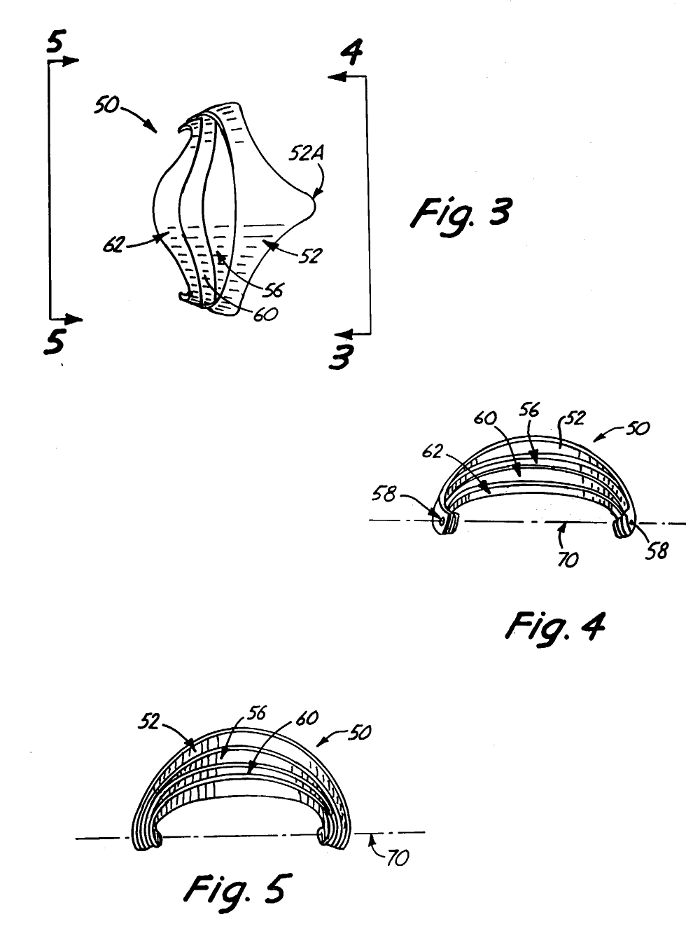

As can be seen in FIGS. 3, 4 and 5, hood 50 has nesting sections that fit inside each other, and with pivot pins 58 pivoting about axes shown at 70, extending and retracting moveable sections 56, 60 and 62 can take place easily. Stationary section 52 is curved and can have a protruding tip 52A facing away from the user's head. Each of the sections 56, 60 and 62 have edges that are curved in order to provide a desired configuration.

As shown in FIG. 7, moveable sections 56, 60 and 62 can be pivoted about the pivot bolts or pins 58 to a retracted position, wherein only a small portion of each section is visibleseen, and a large area indicated at 72 is provided above headrest 22 for access of air or light, or for conversation.

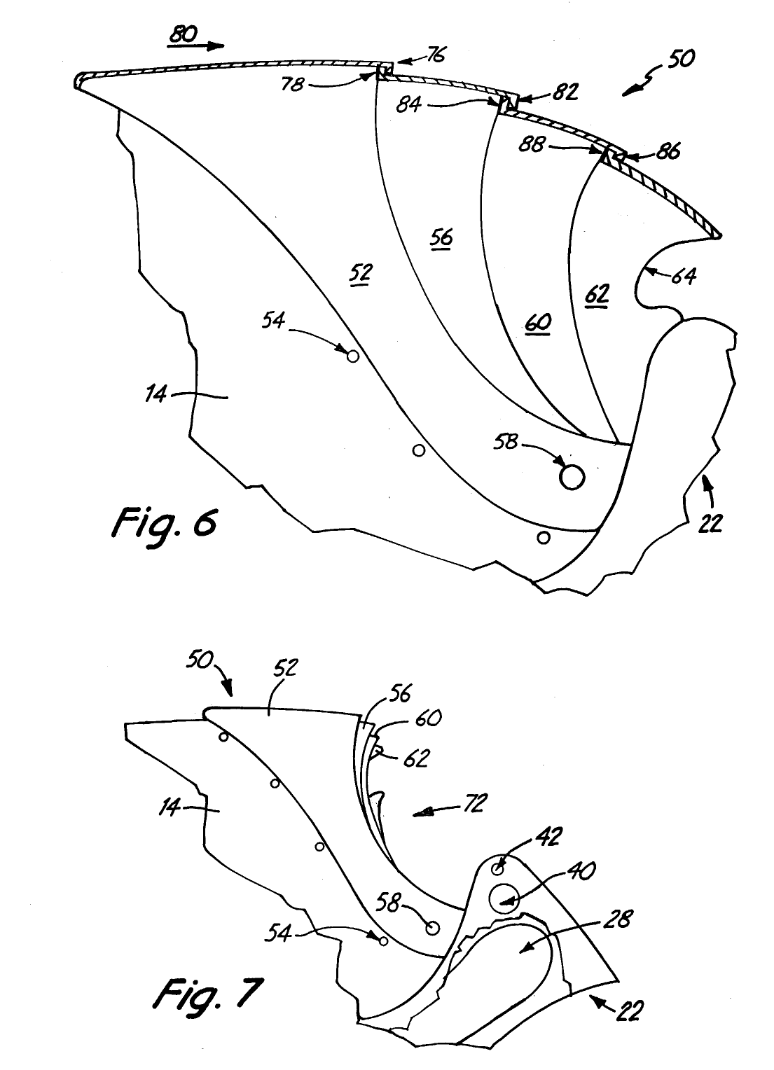

In FIG. 6, the way that sections 52, 56, 60, 62 are formed to stop the outward pivoting or extension of hood 50 is illustrated. Stationary section 52 has a forward downturned lip or rib 76 at its outer edge, and the next smallest section 56 has an upwardly extending rib or lip 78. Lip of rib 76 slides over the surface of section 56 and will mate with the downwardly extending lip 76 and stop movement in direction as indicated by the arrow 80 in FIG. 6. Second section 56 also has a downwardly extending rib or lip 82 at its outer edge. Second section 56 is slidable over the outer surface of the next section 60, which has an upturned rib or lip 84. Downwardly extending lip 82 rides against the outer surface of section 60and stops against lip 84 when the hood segments are pivoted to their extended position. Section 60 is also slidable relative to section 62. Section 60 has a downwardly extending rib or lip 86 that will ride against the outer surface of section 62, which in turn has an upwardly extending rib or lip 88 that will engage lip 86 and prevent further movement in the direction of the arrow 80 about pivot pins 58.

The ribs or lips 76, 82 and 86 all will permit the segments to move in direction opposite from that indicated by the arrow 80 to the retracted position illustrated in FIG. 7.

The parts of the present invention can be made of any suitable molded plastic or other material, and in any configurations as desired, but some type of a lip or rib that provides for an interference stop when the parts are pivoted to their extended position is useful in keeping the parts from separating too far.

The hood can be decorated in various colors, as desired, and it can be attached to the cover 14 in any desired way.

Although the present invention has been described with reference to preferred embodiments, workers skilled in the art will recognize that changes may be made in form and detail without departing from the spirit and scope of the invention.

What is claimed is:

1. A personal therapy compartment comprising a hood portion adapted to attach to the personal therapy compartment, the hood portion comprising a plurality of curved nested sections adapted to extend to a closed position to cover a substantial portion of the head of a user and to retract to an open position.

2. The personal therapy compartment of claim 1 further comprising a base assembly and a cover portion, wherein the base assembly is coupled to the cover portion, and the hood portion is attached to an end of the cover portion.

3. The personal therapy compartment of claim 2 wherein the cover portion is coupled to the base assembly by a hinge at an end of the cover portion opposite the hood portion.

4. The personal therapy compartment of claim 1 further comprising a pivot connecting the plurality of curved nested sections together to pivot between an extended and a retracted position.

5. The personal therapy compartment of claim 2 wherein the plurality of curved nested sections comprise a stationary section fixed to the cover portion and a first moveable section that slidably engages the stationary section.

6. The personal therapy compartment of claim 5 wherein the stationary section includes a downward-turned lip and the second section includes an upward-turned lip, wherein the downward-turned lip of the stationary section engages the upward-turned lip of the second section to stop extending movement of the second section while the plurality of curved nested sections is being extended.

7. The personal therapy compartment of claim 6 further comprising a third section that slidably engages the second section, the third section having a rearward upward-turned lip positioned opposite relative to the direction the plurality of curved nested sections is extended and a forward downward-turned lip, the second section further comprising a forward downward-turned lip that engages the rearward upward-turned lip of the third section to stop extending movement of the third section while the plurality of curved nested sections is being extended.

8. The personal therapy compartment of claim 7 further comprising a fourth section that slidably engages the third section, the fourth section having a rearward upward-turned lip positioned opposite relative to the direction the plurality of curved nested sections is extended, wherein the forward downward-turned lip of the third section engages the rearward upward-turned lip of the fourth section to stop extending movement of the fourth section while the plurality of curved nested sections is being extended.

9. The personal therapy compartment of claim 8 wherein the fourth section has a forward edge that is scalloped when viewed from a transverse direction relative to the direction the plurality of curved nested sections is extended.

10. The personal therapy compartment of claim 8 wherein the stationary section has a tip that protrudes opposite the direction the plurality of nested sections is extended at the approximate center of the stationary section.

11. The personal therapy compartment of claim 2, the base assembly further comprising an interior bed portion supported within the base assembly and a headrest portion coupled to the interior bed portion.

12. The personal therapy compartment of claim 11, the headrest portion further comprising a headrest pillow, wherein the hood portion substantially covers the headrest pillow when the curved nested sections are fully extended.

13. The personal therapy compartment of 11 further comprising a heater to heat an interior chamber of the personal therapy compartment.

14. The personal therapy compartment of claim 11 further comprising a steamer to generate steam for an interior chamber of the personal therapy compartment.

15. The personal therapy compartment of claim 5 wherein the stationary section is the outermost of the plurality of curved nested sections.

16. The personal therapy compartment of claim 1 wherein the hood portion comprises molded plastic.

17. A personal therapy compartment comprising:
a base assembly;
a cover portion coupled to the base assembly;
a hood portion attached to an end of the cover portion, the hood portion having a plurality of curved nested sections comprising a stationary section fixed to the cover portion and a second section that slidably engages the stationary section, wherein the plurality of curved nested sections is adapted to extend to a closed position to cover a substantial portion of the head of a user and to retract to an open position; and
a pivot connecting the plurality of curved nested sections together to pivot between an extended and a retracted position.

18. A hood portion adapted to be attached to a personal therapy compartment, the hood portion comprising a plurality of curved nested sections comprising a stationary section fixed to the personal therapy compartment and a first moveable section that slidably engages the stationary section, the stationary section including a downward-turned lip and the first moveable section including an upward-turned lip, the hood portion further comprising a pivot connecting the plurality of curved nested section together to pivot between an extended closed position to cover a substantial portion of the head of a user and a retracted open position, wherein the downward-turned lip of the stationary section engages the upward-turned lip of the first moveable section to stop extending movement of the first movable section while the plurality of curved nested sections is being extended.
